(19) United States
(12) Patent Application Publication
(10) Pub. No.: US 2011/0011727 A1
(43) Pub. Date: Jan. 20, 2011

(54) System and method for conversion of molecular weights of fluids

(76) Inventors: William M. Sackinger, Fairbanks, AK (US); Halim Hamid Redhwi, Dhahran (SA); Abdullah M. Aitani, Dhahran (SA)

Correspondence Address: LITMAN LAW OFFICES, LTD., PATENT LAW BUILDING, 8955 CENTER STREET, MANASSAS, VA, 20110, US

(21) Appl. No.: 12/458,550

(22) Filed: Jul. 15, 2009

(51) Int. Cl. C10G 15/08; B01J 19/08; B01J 19/12

(52) U.S. Cl. 204/155; 204/559; 204/172; 422/186.04; 422/186.03

(57) ABSTRACT

The system and method for conversion of molecular weights of fluids includes an elongate metallic pipe. A liquid, e.g., a hydrocarbon liquid, is caused to flow through the pipe. A center electrode is mounted within the pipe coaxially with the pipe axis and the flow direction, the electrode being insulated from the pipe wall. The center electrode and the pipe wall are connected to the terminals of a voltage source to create an electric field extending radially between the center electrode and the pipe wall. A source of gamma radiation positioned either within the center electrode or external to the pipe directs gamma rays transverse to the direction of fluid flow. The combined radiation and electric field disrupts carbon-sulfur, carbon-hydrogen, and carbon-carbon bonds, creating ionization zones and resulting in the formation of lower molecular weight compounds. Optionally, a magnetic field may be superimposed in the direction of fluid flow.

### BACKGROUND OF THE INVENTION

1. Field of the Invention

The present invention relates to apparatus and methods for the cracking or reformation of hydrocarbons, and particularly to a system and method for conversion of molecular weights of fluids, which increases the value of petroleum through the removal of impurities and the non-catalytic reforming of high molecular weight hydrocarbons to lower molecular weight compounds having greater economic value.

2. Description of the Related Art

In the production and processing of crude oil and of refined petroleum products, it is often desirable to increase the value, both in terms of monetary value and in terms of essential resources, of a liquid stream of mixed hydrocarbon molecules. For example, it is desirable to remove sulfur and heavy-metal compounds from the liquid stream, and, in some cases, to convert large hydrocarbon molecules into smaller hydrocarbon molecules, which are more useful as fuels and petrochemical feedstocks.

It may be further desirable to convert aromatic hydrocarbons into alkanes and olefins. Although catalytic methods are available to a limited extent for such purposes, these methods involve costs for catalyst replacement and have limitations with regard to operating temperatures, pressures, flow rates and the types of chemical transformations that can be accomplished. For example, sulfur and sulfur compounds have been removed by catalytic contact decomposition by nickel, natural silicates, bauxite, or alumina, by cracking followed by reduction or hydrogenation, or by reaction with various chemical absorbents. Furthermore, the process of thermolytic cracking and catalytic reformation to improve the octane rating of gasoline is well known.

Although electrical methods for the conversion of molecular weights using plasma processes have been described or proposed for gases, and for mixtures of gases and particulates, such methods are not generally available for application to hydrocarbon liquids at normal temperatures and pressures. For example, an article presented to the Diesel Engine Emission Reduction Workshop in August-September 2004 by Bromberg et al. described MIT's efforts to develop a “plasmatron” fuel reformer for the on-board production of hydrogen-rich gas in vehicles, e.g., for hydrogen fuel cells, from hydrocarbon feedstocks, such as petroleum products, ethanol, and vegetable oils. The plasmatron uses a flowing air/fuel mixture that encounters a plasma discharge of several thousand volts, with currents of hundreds of milliamperes. The plasma region is followed by a homogenous reactor where products are formed at about 1,000° C. A catalyst may optionally be used to increase the output of hydrogen gas. However, it appears that the plasmatron converter is still in development and not ready for practical implementation in production vehicles.

None of the above inventions, taken either singly or in combination, is seen to describe the instant invention as claimed. Thus, a system and method for conversion of molecular weights of fluids solving the aforementioned problems is desired.

### SUMMARY OF THE INVENTION

The system and method for conversion of molecular weights of fluids provides an apparatus and method for reducing the average molecular weight of a hydrocarbon liquid, such as a petroleum-based fluid mixture, through application of an electrical field and a source of ionizing radiation, such as gamma radiation. The system includes an elongate metallic pipe, which may have any cross-sectional shape. A hydrocarbon liquid is caused to flow through the pipe. A center electrode is mounted within the pipe coaxially with the pipe axis and the flow direction, the electrode being insulated from the pipe wall. The center electrode and the pipe wall are connected to the terminals of a voltage source to create an electric field extending radially between the center electrode and the pipe wall. A source of gamma radiation positioned either within the center electrode or external to the pipe directs gamma rays transverse to the direction of fluid flow. The combined radiation and electric field disrupts carbon-sulfur, carbon-hydrogen, and carbon-carbon bonds, creating ionization zones and resulting in the formation of lower molecular weight compounds.

The ionization zones will include both free electrons and positive ions. The applied electric field may be a pulsed source of very high voltage, so that the electron flow is accelerated, causing high impact collisions with neutral molecules, further accelerating ionization of the fluid. The system may be enhanced by superimposing a magnetic field in the axial flow direction, so that the electrons and positive ions move in crossed electric and magnetic fields. The result of the ionization reactions will generally be lower molecular weight compounds, although some larger molecular weight compounds will also be formed.

Further, the ionization and energization of the fluid mixture increase the temperature of the fluid. A heat exchanger may be further provided for removing thermal energy from the fluid for use elsewhere within the system, or for powering external components. Additionally, the pipe may be provided with a transparent window for optically viewing and analyzing the reactions within the housing.

These and other features of the present invention will become readily apparent upon further review of the following specification and drawings.

### BRIEF DESCRIPTION OF THE DRAWINGS

FIG. 1 is a diagrammatic side view of a system for conversion of molecular weights of fluids according to the present invention.

FIG. 2 is a diagrammatic view in axial section of the system for conversion of molecular weights of fluids according to the present invention, showing the orientation of the applied electric and magnetic fields and the applied gamma radiation.

Similar reference characters denote corresponding features consistently throughout the attached drawings.

### DETAILED DESCRIPTION OF THE PREFERRED EMBODIMENTS

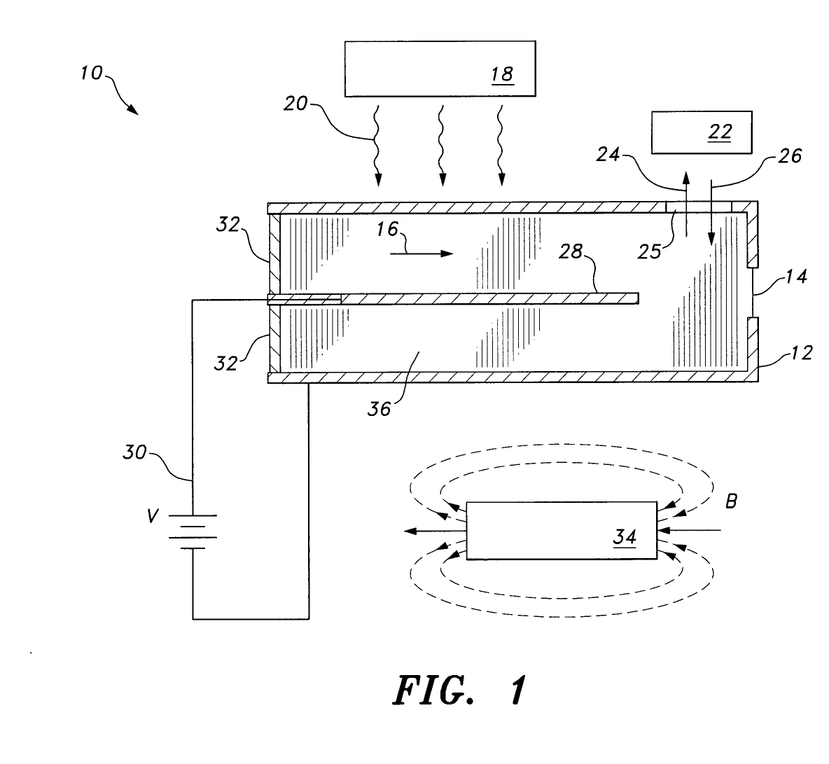

As illustrated in FIG. 1, the system 10 for the conversion of molecular weights of fluids includes an elongated metallic pipe 12. The pipe 12 may have a closed end with an optically transparent window 14, allowing the user to view the chemical reactions, both for observational and analysis purposes, the fluid entering and exiting the pipe 12 through transversely extending inlet and outlet pipes (not shown) at opposite ends of the pipe 12. Alternatively, fluid may enter and exit the pipe 12 through coaxial inlet and outlet ports, with the observation window being disposed laterally in the wall of the pipe 12. Fluid flows through the reaction chamber 36 defined by pipe 12 in the flow direction indicated by directional arrow 16.

The fluid is a liquid mixture of hydrocarbons, e.g., a petroleum product, such as crude oil, kerosene, diesel oil, etc. Alternatively, the fluid may be ethanol, vegetable oil, or any other mixture that it is desired to reform into products of different molecular weight. The fluid may be forced into housing, along path 16, through any suitable method, such as by use of a pressurizing pump, and the products may be extracted by any suitable method.

Although shown as a cylindrical pipe in the drawings, pipe 12 may have any desired cross-sectional contour, e.g., square or rectangular tubing. A center electrode 28 extends coaxially within the chamber 36 defined by pipe 12 in the fluid flow direction 16, and is isolated from the wall of the pipe 12 by insulators 32. Although shown concentrically mounted within pipe 12 in the drawings, it will be understood that the scope of the present invention extends to an electrode 28 mounted eccentrically within pipe 12 but extending coaxially in the flow direction 16.

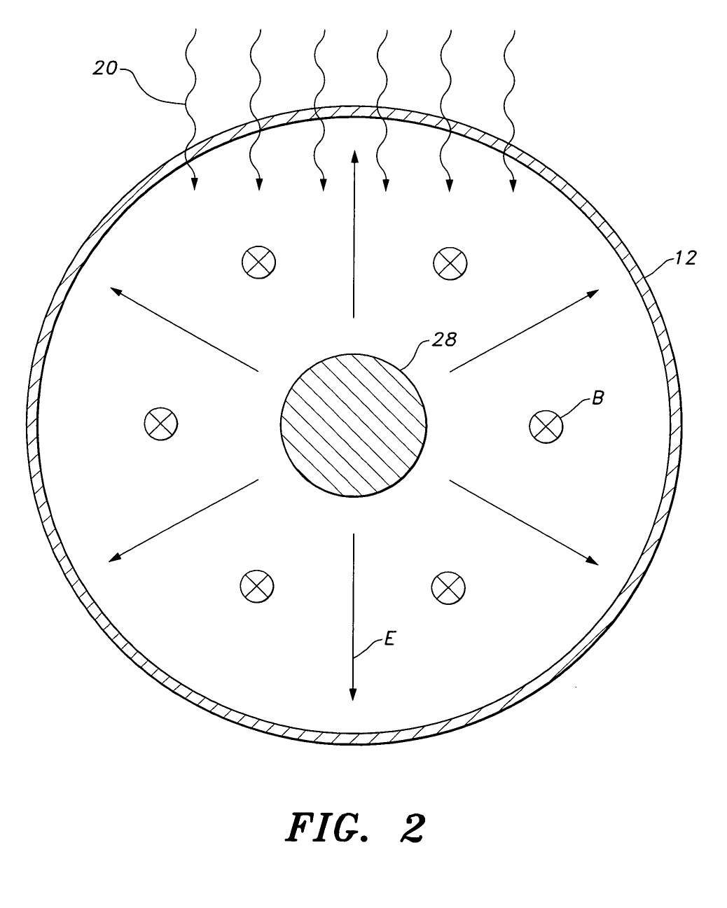

The wall of pipe 12 and the center electrode 28 are connected to an external voltage supply V to generate an electric field E, which extends in a substantially radial direction, as shown in FIG. 2. A source of ionizing radiation 18 is provided for generating ionizing radiation 20, which is transmitted into reaction chamber 36. The ionizing radiation 20 is preferably gamma radiation. The radiation source 18 may be positioned external to pipe 12, as shown, or, alternatively, may be located within electrode 28. When fluid flows within pipe 12, the ionizing radiation 20 creates a multiplicity of ionization events within the fluid. Preferably, fluid continuously flows through pipe 12 so that the fluid is continuously ionized within reaction chamber 36.

The ionization events within the fluid involve the destruction of the chemical bonds within the molecules forming the fluid. In a mixed hydrocarbon fluid, this destruction may include, for example, the disruption of carbon-sulfur bonds, carbon-hydrogen bonds, and carbon-carbon bonds. Additionally, free electrons and positive ions are created during the ionization events, as well as ions and molecules being energized to their excited states. Decay of these excited states results in the emission of photons and, to a lesser extent, the subsequent emission of further electrons. The generation of charged particles within the fluid, both in the form of free electrons and new positive ions, results in new chemical reactions and in the formation of new molecules.

The chemical activity of the ionized fluid is enhanced by the presence of the electrical field E, induced by voltage source V. The voltage source V is, preferably, a relatively high voltage source so that the free electrons are accelerated by electric field E, preferably acquiring several electron volts of energy, so that the electrons will collide with adjacent neutral molecules, generating further ionization events. Additional electrons will be created by these secondary ionization events, which, in turn, are also accelerated by the electric field E, creating further ionization events. This cascading ionization process results in the creation of new chemical reactions, the emission of photons in a wide spectrum of wavelengths, and in other energetic processes within the fluid. Voltage source V is connected to pipe 12 and electrode 28 via conductors 30.

This ionization and energization of the fluid enhances the decomposition of the molecules that were initially ionized by radiation 20, which results in the recombination of these ions with other molecules present in the fluid, such as oxygen, nitrogen, hydrogen, argon and water, which may be present if there is air dissolved in the fluid. The newly formed molecules will generally have a smaller molecular weight than the original molecules found within the fluid, though some larger weight molecules will be created. The average molecular weight of the fluid, however, will be decreased by the ionization process.

The energy added to the fluid by radiation 20 and electric field E produces chemical conversions, photons and heat. As the fluid temperature increases, the production of new active zones within the fluid and the rate of ionization will increase, thus increasing the rate of chemical conversion activity. Once the fluid has passed through pipe 12 for a time and length sufficient to generate desired new molecules, a heat exchanger 22 may extract thermal energy from the fluid for any desired usage.

Heat exchanger 22 may be positioned within the fluid path, or may be positioned external to pipe 12, as shown in FIG. 1. In this embodiment, a port 25 is formed through pipe 12 through which the heated fluid exits pipe 12 (represented by directional arrow 24), and the newly cooled fluid is re-input to pipe 12 back through port 25 (represented by directional arrow 26).

As a further alternative, a fluid feedback loop may be added so that fluid exiting the pipe 12 is fed back into pipe 12 for the creation of a fluid having an even smaller average molecular weight.

Voltage V may be either continuous or pulsed. However, in the preferred embodiment, voltage source V provides a pulsed voltage. The electrical effect on the ionization activity only takes place when the voltage source is “on” during the pulsed cycle.

Additionally, a magnet 34, such as a ferromagnet, an electromagnet or the like, may be provided for generating a magnetic field B. The magnet 34 is arranged so that magnetic field B, as shown in FIG. 2, travels along a direction substantially parallel to fluid flow 16 within reaction chamber 36. Magnetic field B allows for the confinement of ion motion to smaller regions within the ionization zones, thus providing a larger number of collisions between ions and neutral molecules within the zones.

The preferable orthogonal arrangement between electric field E and magnetic field B within chamber 36 will generate cycloidal motion in the charged particles, although no net energy is transferred to the charged particles by the magnetic field unless the strength of the magnetic field is time-variable. Magnetic field B may be static, thus creating a change in direction only of the motion of the particles, rather than an increase in kinetic energy. With the particles moving in a substantially circumferential direction, a higher probability of collision with neutral particles is generated.

The energy acquired by a charged particle between the creation of that charged particle, via ionization, and the collision of the charged particle with a neutral molecule is preferably greater than the ionization energy of the neutral molecule. The mean free path of the charged particles as they move in a quarter-cycloid trajectory is, statistically, of the same order as the mean free path for their collision with a neutral molecule. Voltage V may be user selectable, allowing for the adjustment to accomplish such collisions.

With the application of the crossed electric and magnetic fields, a greater number of collisions and, thus, a greater number of molecular conversions, is achieved. The plasma existing within the active zones grows by the cascade process described above during the period the pulsed voltage V is applied, after which the recombination of ions and electrons will take place.

Although current will be induced in conductors 30 during the time of movement of charges, the actual arrival of charges at the boundary electrodes 12, 28 will provide a minimal effect during operation of system 10. In the example of the removal of sulfur atoms from their bonds in large aromatic hydrocarbon molecules, this ionic activity, which also includes the creation of hydrogen ions, will not only disbond the sulfur, but will also lead to the production of hydrogen sulfide gas, which dissolves in the liquid. The dissolved hydrogen sulfide gas may be removed from the output stream through conventional methods, thus resulting in lower sulfur content in the fluid following the conversion process of system 10.

The liquid stream feeding system 10 may be a mixture of hydrocarbons or may be an emulsified mixture of two or more liquids, which are intended for the conversion process described above. Suitable gases may also be dissolved in the liquid stream if the user desires gas/liquid reactions to take place within system 10.

System 10 may be used for the treatment of crude oil prior to delivery of the crude oil to a refinery. Based upon plasma conversion experiments using pure gaseous alkane feedstocks at the C₆ and C₁₆ level, it has been found that acetylene is one of the major products. Acetylene is a known feedstock for petrochemical factories and can be used as a substitute for ethylene. System 10 may further be utilized for the removal of a large percentage of sulfur from a hydrocarbon mixture. Further, system 10 may be used for the conversion of heavy crude oil into a mixture of lighter molecular weight hydrocarbons, thus increasing the value of the fluid.

It is to be understood that the present invention is not limited to the embodiments described above, but encompasses any and all embodiments within the scope of the following claims.

We claim:

1. A system for conversion of molecular weights of fluids, comprising:
an elongated pipe defining a reaction chamber adapted for fluid flow of a liquid in an axial flow direction, the pipe being made from an electrically conductive material;
an electrode disposed within the reaction chamber and extending coaxially in the direction of fluid flow, the electrode being electrically insulated from the pipe;
a voltage source electrically connected to the pipe and the electrode, the voltage source impressing opposite polarities on the pipe and the electrode in order to generate a radially extending electric field between the pipe and the electrode; and
an ionizing radiation source directing ionizing radiation in the reaction chamber transverse to the direction of fluid flow, whereby the liquid flowing through the pipe is ionized and energized so that the molecular composition of the liquid is reformed, being converted to compounds of different molecular weight.

2. The system for conversion of molecular weights as recited in claim 1, further comprising a magnet disposed adjacent said pipe and oriented to generate a magnetic field axially though the reaction chamber defined by said pipe.

3. The system for conversion of molecular weights as recited in claim 1, wherein said ionizing radiation source is disposed external to said pipe.

4. The system for conversion of molecular weights of fluids as recited in claim 1, wherein said ionizing radiation source is disposed internal to said electrode.

5. The system for conversion of molecular weights as recited in claim 1, further comprising a heat exchanger connected to said pipe for removing and recovering heat energy generated during conversion of the molecular weights of the fluid.

6. The system for conversion of molecular weights as recited in claim 5, wherein said heat exchanger comprises a heat exchanger conduit exiting and re-entering said pipe and means for extracting heat from a portion of the conduit external to said pipe.

7. The system for conversion of molecular weights as recited in claim 1, further comprising a transparent window formed in said pipe for viewing and analyzing said fluid.

8. The system for conversion of molecular weights as recited in claim 1, wherein said voltage source is a pulsed voltage source.

9. The system for conversion of molecular weights according to claim 1, wherein said ionizing radiation source comprises a source of gamma ray radiation.

10. A method for conversion of molecular weights of a liquid, comprising the steps of:
establishing a flow of the liquid through a conduit in order to establish a fluid flow;
irradiating the fluid flow with gamma rays directed transverse to the flow of the fluid at an intensity and for a path length and duration of time sufficient to ionize and energize the fluid, whereby molecular bonds are broken and the liquid is reformed and converted to compounds of different molecular weight.

11. The method for conversion of molecular weights according to claim 10, further comprising the step of generating a radially extending electric field through at least a portion of the axial length of the conduit in order to accelerate flow of electrons and ions formed by ionization of the hydrocarbon liquid.

12. The method for conversion of molecular weights according to claim 11, wherein said electric field is a static electric field, said generating step further comprising generating the electric field throughout the duration of ionization time of the hydrocarbon fluid.

13. The method for conversion of molecular weights according to claim 11, wherein said electric field is a dynamic electric field, said generating step further comprising applying a voltage to spaced apart electrodes in the conduit in pulses of finite time duration in order to periodically accelerate flow of electrons and ions formed by ionization of the hydrocarbon liquid.

14. The method for conversion of molecular weights according to claim 11, further comprising the step of superimposing a magnetic field axially through the conduit, whereby ions and free electrons formed in the conduit are subjected to crossed electric and magnetic fields.

15. The method for conversion of molecular weights according to claim 14, wherein said magnetic field comprises a static magnetic field.

16. The method for conversion of molecular weights according to claim 10, further comprising the step of extracting heat generated during converting the molecular weight through a heat exchanger.

17. The method for conversion of molecular weights according to claim 10, further comprising the step of visually monitoring conversion of the molecular weight through an optical view port mounted in the conduit.

18. The method for conversion of molecular weights according to claim 10, further comprising the step of monitoring progress of converting the molecular weight by periodic testing.

19. The method for conversion of molecular weights according to claim 10, wherein the liquid comprises at least one hydrocarbon compound in said establishing step.
